(19) United States
(12) Patent Application Publication
(10) Pub. No.: US 2011/0200351 A1
(43) Pub. Date: Aug. 18, 2011

(54) IMAGE FORMING APPARATUS AND IMAGE FORMING METHOD

(75) Inventors: Satoshi CHIBA, Suwa (JP); Shinichi TANAKA, Shiojiri (JP)

(73) Assignee: SEIKO EPSON CORPORATION, Tokyo (JP)

(21) Appl. No.: 13/021,082

(22) Filed: Feb. 4, 2011

(30) Foreign Application Priority Data
Feb. 15, 2010 (JP) 2010-030070

(51) Int. Cl. G03G 21/20; G03G 15/01

(52) U.S. Cl. 399/92; 399/304

(57) ABSTRACT

An image forming apparatus includes an image carrier belt for carrying an image, a transfer roller rotating on a rotating shaft and forming a transfer nip with the image carrier belt downward in a vertical direction from a virtual horizontal plane perpendicular to the vertical direction including the centerline of the rotating shaft, an airflow-generating unit for generating a first airflow directed between the image carrier belt and a transfer surface, and a second airflow directed towards the transfer surface from below in the vertical direction, where the image has been transferred by the transfer nip onto a transfer material, and where the image on the transfer material has been transferred onto the transfer surface.

### CROSS-REFERENCE TO RELATED APPLICATIONS

This application claims priority to Japanese Patent Application No. 2010-030070 filed on Feb. 15, 2010. The entire disclosure of Japanese Patent Application No. 2010-030070 is hereby incorporated herein by reference.

### BACKGROUND

1. Technical Field

The present invention relates to an image forming apparatus and an image forming method in which a transfer material passes through a transfer nip between a transfer roller and an image carrier belt.

2. Background Technology

An example of an image forming apparatus in which an image formed on an image carrier is transferred to a transfer material is described in Patent Citation 1. The apparatus described in Patent Citation 1 is an image forming apparatus using the so-called liquid developing system in which an electrostatic latent image is rendered visible using a liquid developer containing toner particles and a carrier liquid. In this apparatus, a transfer material is gripped by a gripping material (gripper) disposed in a portion of the peripheral surface of a press roller (corresponding to a transfer roller), and the transfer material is passed through a nip with a drum-shaped intermediate transfer material (image carrier) so as to wind around the press roller. In this way, an image is transferred to the transfer material. Because the transfer material is passed through the nip while being gripped mechanically in this configuration, strong transfer pressure is applied by the nip, and the transfer material sometimes becomes stuck to the image carrier.

In the image forming apparatus using the liquid developing system described in Patent Citation 2, an image is transferred to a transfer material by a transfer nip formed by a transfer belt and an intermediate transfer belt carrying the image. At this time, the transfer material is separated from the intermediate transfer belt by directing an airflow at the transfer material discharged from the transfer nip.

In other words, the transfer material is gripped by the gripping material of a transfer roller in the technology described in Patent Citation 1, and the transfer material is separated from the intermediate transfer material by directing an airflow at the transfer material in the technology described in Patent Citation 2.
Japanese Translation of PCT International Application No. 2000-508280 (e.g., FIG. 2A) is an example of the related art (hereinafter Patent Citation 1).
Laid-open Patent Publication No. 2009-205131 (e.g., FIG. 4) is an example of the related art (hereinafter Patent Citation 2).

### SUMMARY

### Problems to be Solved by the Invention

It is desirable for the transfer material passing through the transfer nip to assume the shape of the peripheral surface of the transfer roller. However, it is difficult to control this positioning when the transfer material has been separated from the peripheral surface of the transfer roller. The transfer material comes into contact with peripheral members, and the transferred image is disturbed. Also, the transport force of the transfer material obtained by adhering the transfer material to a rotating transfer roller is insufficient, and jams occur due to poor transport.

Furthermore, in a problem discovered and confirmed by the inventors in the present application, when the transfer material has passed through the transfer nip and is being separated from the peripheral surface of the transfer roller, the middle portion of the transfer material sometimes sticks to the intermediate transfer material even when the front end of the transfer material has separated from the intermediate transfer material in the transport direction. This problem with a transfer material that has passed through a transfer nip is neither described in detail nor sufficiently addressed in the patent citations mentioned above.

Advantage of some aspects of the invention is to solve this problem by providing a technology enabling an image forming apparatus or an image forming method in which a transfer material is passed through a transfer nip between a transfer roller and an image carrier belt to allow the transfer material to conform to the peripheral surface of the transfer roller without sticking to the image carrier belt.

### Means Used to Solve the Above-Mentioned Problems

In order to solve this problem, an aspect of the present invention is an image forming apparatus including: an image carrier belt for carrying an image; a transfer roller rotating on a rotating shaft and forming a transfer nip with the image carrier belt downward in a vertical direction from a virtual horizontal plane perpendicular to the vertical direction including the centerline of the rotating shaft; and an airflow-generating unit for generating a first airflow directed between the image carrier belt and a transfer surface, and a second airflow directed towards the transfer surface from below in the vertical direction, the image having been transferred by the transfer nip onto a transfer material, and the image on the transfer material having been transferred onto the transfer surface.

In order to solve this problem, another aspect of the invention is an image forming method including: transferring an image carried by an image carrier belt to a transfer material through a transfer nip formed by the image carrier belt and a transfer roller downward in the vertical direction from a virtual horizontal plane perpendicular to the vertical direction and including the center of rotation of the transfer roller; transporting the transfer material to which the image has been transferred and separating the transfer material from the image carrier belt while generating a first airflow between the image carrier belt and a transfer surface onto which the image on the transfer material has been transferred; and directing a second airflow downward in the perpendicular direction against the transfer surface of the transfer material separated from the image carrier belt.

According to the configuration described above, the transfer material is separated from the image carrier belt by a first airflow directed between the transfer surface of the transfer material and the image carrier belt, and the separated transfer material is pushed against the peripheral surface of the transfer roller by a second airflow. Because the transfer material conforms to the peripheral surface of the transfer roller and is transported after passing through the transfer nip, the positioning of the transfer material can be controlled after passing through the transfer nip, sufficient transport force is applied by the rotation of the transport roller, and both contact with the peripheral members and insufficient transport can be prevented. The invention is especially effective at preventing a phenomenon in which the middle portion of a transfer material upon which an image has been transferred sticks to the image carrier belt (this phenomenon is referred to “in-transit adhesion” below).

Here, the transfer roller can have a recessed portion in the peripheral surface, and a gripping material for gripping the transfer material can be provided in the recessed portion. In this configuration, the transfer material can be gripped by the gripping material and reliably separated from the image carrier belt. The portion of the transfer material not gripped by the gripping material can be prevented from sticking to the image carrier belt by directing an airflow at it as described above.

In this situation, for example, the gripping material can grip the transfer material, the transfer material can be transported to the transfer nip, and the transfer material on which an image has been transferred by the transfer nip can be released downward in the vertical direction from a virtual horizontal plane. In this configuration, the transfer material passed through the transfer material has to conform to the bottom surface of the transfer roller. In this configuration, the transfer material can be prevented from separating from and dropping off the peripheral surface of the transfer roller due to gravity by directing an airflow at the transfer material in the manner described above.

Also, for example, there can be provided a transport unit in which the transfer material is transported while the transfer surface of the transfer material on which an image has been transferred is facing downward in the vertical direction. In a configuration in which the transfer surface is transported face down, an airflow is used in the manner described above to stabilize the positioning of the transfer material transported from the transfer nip via the transport unit. This can prevent the transfer material from coming off the peripheral surface of the transfer roller, the transfer material from making contact with peripheral members, and transporting from being adversely affected by insufficient force.

In a configuration in which a transfer material subjected to the second airflow is suctioned upward in the vertical direction and transported, the transfer material is carried by the suctioning force in the direction opposite that of the gravitational direction. Thus, sagging of the transfer material can be a major issue. However, by applying the invention to this configuration, sagging of the transfer material can be prevented, and the transfer material can be reliably transported.

There can also be provided, for example, a transfer material information input unit to which information about the transfer material is inputted, and a control unit for controlling at least the flow rate of the first airflow and the second airflow based on the information about the transfer material inputted by the transfer material information input unit. The likelihood of in-transit adhesion happening depends on the type of transfer material, especially the thickness and basis weight of the transfer material. For example, it can be difficult to sufficiently hold and maintain the positioning of thin, weak paper, and in-transit adhesion is more likely to happen. Because thick, strong paper can retain its shape, in-transit adhesion is less likely to happen. Because the likelihood of in-transit adhesion happening depends on the type of transfer material, the occurrence of in-transit adhesion can be reliably suppressed by setting at least the flow rate of the first airflow used to separate the transfer material from the image carrier belt and the second airflow used to push the transfer material against the transfer roller and increase the transport force based on information about the transfer material.

### BRIEF DESCRIPTION OF THE DRAWINGS

FIG. 1 is a view representing the image forming apparatus in an embodiment of the invention;

FIG. 2 is a block diagram representing the electrical configuration of the device in FIG. 1;

FIG. 3 is a perspective view representing the overall configuration of the secondary transfer roller;

FIG. 4 is a view representing the opening and closing mechanism for the gripping material;

FIG. 5 is a first view representing the relationship between the phase rotation of the secondary transfer roller and the opening/closing state of the gripping material;

FIG. 6 is a second view representing the relationship between the phase rotation of the secondary transfer roller and the opening/closing state of the gripping material;

FIG. 7 is a view used to explain the in-transit adhesion phenomenon;

FIG. 8 is a view of the secondary transfer roller and the blower unit from above;

FIG. 9 is a view representing the shape of the case for the blower unit;

FIG. 10 is a view representing the operating sequence for the blower unit; and

FIG. 11 is a view representing an example of flow rate settings.

### DETAILED DESCRIPTION OF EXEMPLARY EMBODIMENTS

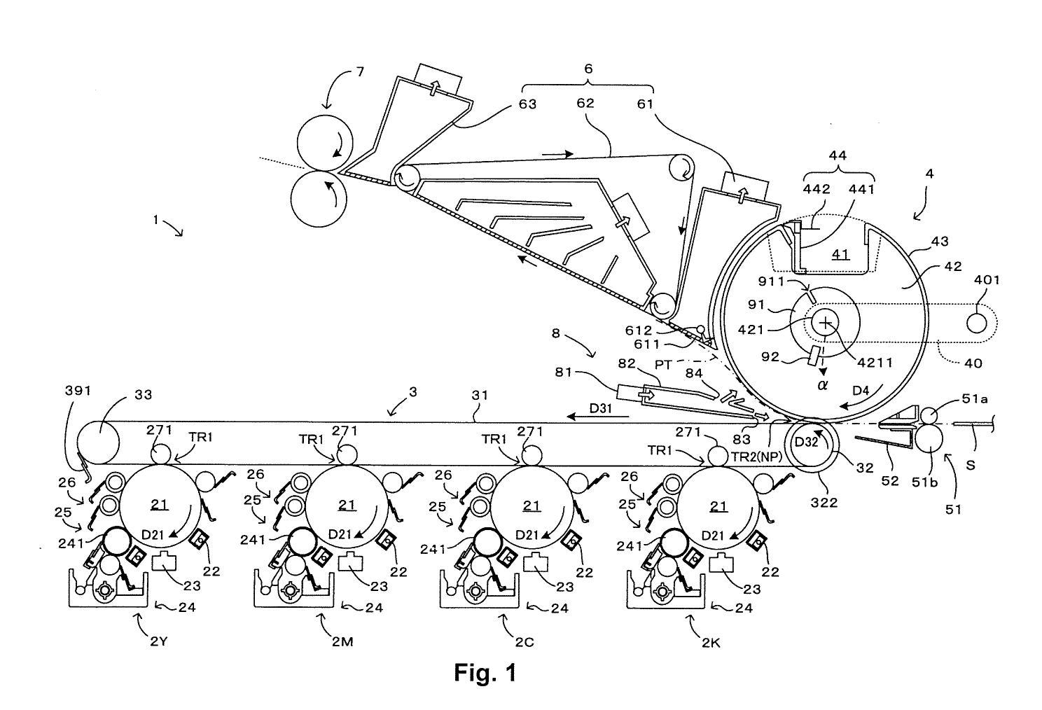

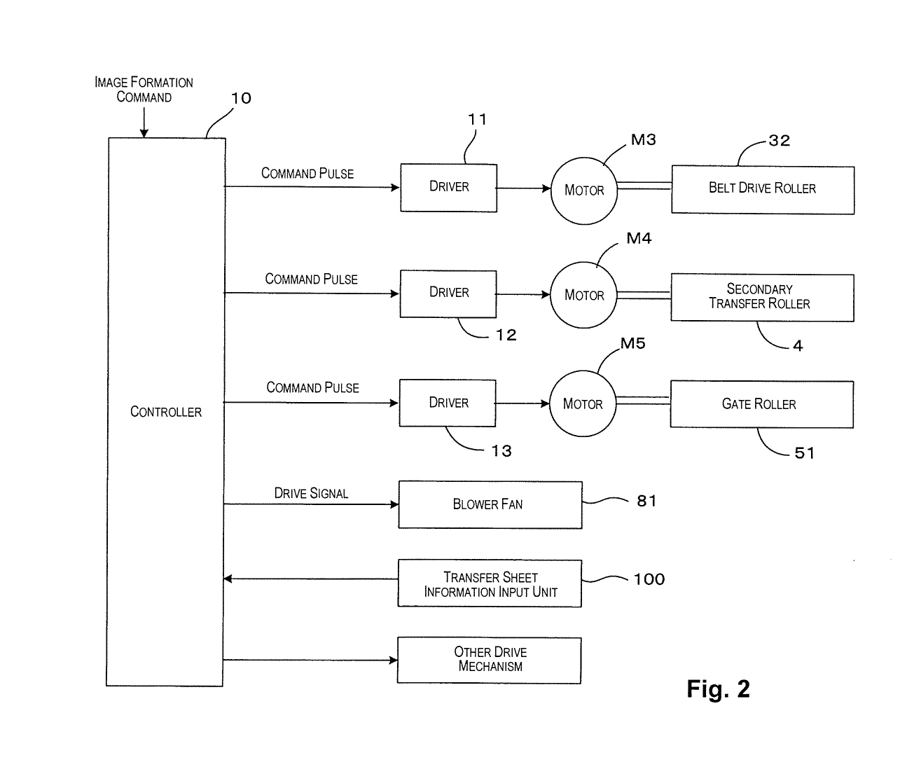

FIG. 1 is a view showing the image forming apparatus in an embodiment of the invention. FIG. 2 is a block diagram showing the electrical configuration of the apparatus in FIG. 1. This image forming apparatus 1 is equipped with four image forming stations 2Y (for yellow), 2M (for magenta), 2C (for cyan), and 2K (for black) used to form different color images. The image forming apparatus 1 can selectively operate in color mode, in which a color image is formed by superimposing toners of four colors, yellow (Y), magenta (M), cyan (C), and black (K), and in monochromatic mode, in which a monochromatic image is formed using only black (K) toner. When an image formation command is sent from an external device such as a host computer to a controller 10 in the image forming apparatus having a CPU and memory, the controller 10 controls the various components in the apparatus, executes a predetermined image forming operation, and forms an image corresponding to the image formation command on a sheet-shaped transfer material S such as copy paper, transfer paper, general-use paper, or a transparent sheet for an overhead projector (OHP).

A photosensitive drum 21 is provided in each image forming station 2Y, 2M, 2C and 2K to form toner images of the various colors on its surface. The photosensitive drums 21 are disposed so that their rotational axes are parallel or nearly parallel to the main scanning direction (perpendicular to the plane of the paper surface in FIG. 1), and the photosensitive drums are rotationally driven at a predetermined speed in the direction of arrow D21 in FIG. 1).

Provided around the periphery of each photosensitive drum 21 sequentially in the rotational direction D21 of the photosensitive drum 21 (clockwise in FIG. 1) are a corona charger 22 for charging the surface of the photosensitive drum 21 to a predetermined electric potential, an exposure unit 23 for exposing the surface of the photosensitive drum 21 to light based on image signals to form an electrostatic latent image, a developing unit 24 for rendering the electrostatic latent image visible as a toner image, a first squeezing unit 25, a second squeezing unit 26, a primary transfer unit for transferring the toner image to the intermediate transfer belt 31 in the transfer unit 3, a cleaning unit for cleaning the surface of the photosensitive drum 21 after the transfer, and a cleaner blade.

The charger 22 does not touch the surface of the photosensitive drum 21, and a corona charger common in the art can be used in the charger 22. When a scorotron charger is used as the corona charger, the positive wire current flows to the charge wire of the scorotron charger, and a direct current (DC) grid charging bias is applied to the grid. By charging the photosensitive drum 21 with a corona discharge from the charger 22, the potential of the surface of the photosensitive drum 21 can be set to a nearly uniform potential.

The exposure unit 23 exposes the surface of the photosensitive drum 21 to a laser beam based on the image signals supplied by an external device, and forms an electrostatic latent image corresponding to the image signals. The exposure unit 23 can be configured to scan with a laser beam from a semiconductor laser using a polygonal mirror or to use a line head in which light-emitting elements are arranged in the scanning direction.

Toner is applied to the electrostatic latent image formed in this manner from a developing roller 241 provided in the developing unit 24, and the electrostatic latent image is developed by the toner. In the developing unit 24 of this image forming apparatus 1, toner development is performed using a liquid developer in which a toner is dispersed in a carrier liquid at a weight ratio of approximately 20%. The liquid developer used in this embodiment can be a volatile liquid developer having a low concentration (approximately 1-2 wt %) of the commonly used Isopar (trademark: Exxon) as the carrier, and a low viscosity, and having volatility at room temperature. The liquid developer can also be a non-volatile liquid developer having a high concentration and a high viscosity, and having non-volatility at room temperature. In other words, the liquid developer in the invention is a high-viscosity (i.e., a viscoelasticity of approximately 30 to 300 mPa·s at 25° C. and a shearing velocity of 1000 l/s using a Haake RheoStress RS600) liquid developer, in which solid particles of a colorant such as a pigment dispersed in a thermoplastic resin having an average particle size of 1 μm are added along with a dispersant to a liquid solvent such as an organic solvent, silicone oil, mineral oil or cooking oil to obtain a toner solid concentration of approximately 20%.

A first squeezing unit 25 is provided downstream from the developing position in the rotational direction D21 of the photosensitive drum 21, and a second squeezing unit 26 is provided downstream from the first squeezing unit 25. A squeeze roller is disposed in each squeezing unit 25, 26. The squeeze rollers come into contact with the surface of the photosensitive drum 21 to remove the excess carrier liquid and fogging toner from the toner image. In this embodiment, the excess carrier liquid and fogging toner are removed using two squeeze units 25, 26, but the invention is not limited to this number and arrangement of squeezing units. For example, a single squeezing unit can be provided.

After passing through the squeezing units 25, 26, the toner image is transferred to the intermediate transfer belt 31 by the primary transfer unit. This intermediate transfer belt 31 is stretched around a pair of belt transport rollers 32, 33 arranged at some distance from each other, and the belt is rotated in a predetermined direction D31 by a roller driven by a belt drive motor M3. More specifically, among the belt transport rollers 32, 33, the left roller 32 in FIG. 1 is the drive roller, and belt drive motor M3 is connected mechanically to this drive roller 32. Also, in this embodiment, a driver 11 is provided to drive the belt drive motor M3. Drive signals corresponding to command pulses sent from the controller 10 are outputted to the belt drive motor M3 for position control. In this way, the drive roller (belt transport roller) 32 is rotated in the direction of the arrow in FIG. 1 at a peripheral velocity corresponding to the command pulses, and the surface of the intermediate transfer belt 31 moves in direction D31 at a constant speed.

The primary transfer unit has a backup roller 271, and this backup roller 271 is disposed opposite the photosensitive drum 21 with the intermediate transfer belt 31 interposed between them at the primary transfer position TR1, where the toner image on the photosensitive drum 21 is transferred to the intermediate transfer belt 31. Toner images are transferred by the transfer units for each color to superimpose the toner images of the various colors on the photosensitive drums 21 to the intermediate transfer belt 31 and form a full color toner image.

The toner image transferred to the intermediate transfer belt 31 is transported to the secondary transfer position TR2. At the secondary transfer position TR2, a secondary transfer roller 4 is disposed opposite the drive roller 32 of the transfer unit 3 with the intermediate transfer belt 31 interposed between them. As shown in FIG. 2, the secondary transfer roller 4 is rotationally driven by the secondary transfer roller drive motor M4, and rotated in the direction of arrow D4 in FIG. 1. The secondary transfer roller drive motor M4 is controlled by drive signals outputted from the driver 12 based on command pulses from the controller 10. At the secondary transfer position TR2, the monochromatic or polychromatic toner image formed on the intermediate transfer belt 31 undergoes secondary transfer to a transfer material S transported via the transport route PT by gate rollers 51 (a pair of rollers 51a, 51b). A sheet guide 52 is provided between the gate rollers 51 and the secondary transfer position TR2 to send the transfer material S to the secondary transfer position TR2 without any contact occurring with the secondary transfer roller 4 and the intermediate transfer belt 31.

A photosensor cam 91 is provided on the rotational shaft 421 of the secondary transfer roller 4 to detect the phase rotation of the secondary transfer roller 4. The photosensor cam 91 is disk-shaped and has a slit-shaped notch 911 in a portion of the peripheral surface, and rotates with the secondary transfer roller 4. A photosensor 92 composed of a photointerrupter is provided, for example, on the case side of the apparatus. As the secondary transfer roller 4 rotates, a synchronization signal synchronized with the rotation of the secondary transfer roller 4 is outputted by the photosensor 92 each time the notch 911 in the photosensor cam 91 passes the detection position of the photosensor 92. The phase rotation of the secondary transfer roller 4 is detected in this way, and the controller 10 controls the operational timing of the various components in the apparatus based on these synchronization signals.

The transfer material S on which the toner image has been transferred is sent to the transport mechanism 6 from the secondary transfer roller 4 via the transport route PT. In the transport mechanism 6, a first suction unit 61, a transfer material transport unit 62, and a second suction unit 63 are arranged in successive order along the transport route PT. These components work together to transport the transfer material S to the fixing unit 7. At this time, the transfer material S is transported (back transported) with the upper surface opposite the image transfer surface being suctioned so that the image transfer surface on which the toner image has been transferred from the intermediate transfer belt 31 is facing downward in the vertical direction. In FIG. 1, the white arrows applied to the first suction unit 61, the transfer material transport unit 62, and the second suction unit 63 indicate the directions of the airflows formed when the various components operate and the transfer material S is suctioned. This same applies to the other drawings mentioned below.

In the transport direction for the transfer material S along the transport route PT, a sheet detecting sensor 612 is provided near the suction surface 611 of the first suction unit 61 arranged adjacent to the rear of the secondary transfer roller 4 to detect whether or not the transfer material S at that position. Output signals from the sheet detecting sensor 612 are inputted to the controller 10.

In order to reliably send the transfer material S to the first suction unit 61 after the secondary transfer of the toner image without contaminating the image, a blower unit 8 is provided in this embodiment between the secondary transfer position TR2 and the first suction unit 61 so as to face the secondary transfer roller 4 on the exit side of the transfer nip NP from which the transfer material S is discharged. In this blower unit 8, the airflow generated by the operation of the blower fan 81 used to generate the air flow is discharged in the directions of the white arrows from openings 83, 84 in the case 82. Opening 83 opens in front of the transfer nip NP. By directing the airflow from the opening 83 in the direction of the transfer nip NP, the airflow can be directed between the front end of the transfer material S released from the grip of the gripping material 44 for the secondary transfer roller 4, and the intermediate transfer belt 31, and the transfer material S can be separated from the intermediate transfer belt 31.

Opening 84 opens towards the peripheral surface of the secondary transfer roller 4 after it has passed the transfer nip NP. The airflow directed towards the image transfer surface of the transfer material S from this opening 84 pushes the separated transfer material S against the peripheral surface of the secondary transfer roller 4 so that the transfer material is transported by the rotation of the secondary transfer roller 4. The front end of the transfer material S is thus sent towards the first suction unit 61. By directing an airflow towards the transfer material S, the rear end of the transfer material S can be prevented from touching the intermediate transfer belt 31 and contaminating the image when the rear end is discharged from the secondary transfer position TR2.

The fixing unit 7 is provided downstream from the transport route PT on the opposite side of the secondary transfer roller 4 with respect to the transport mechanism 6 (on the left side in FIG. 1). This applies heat and pressure to the toner image transferred to the transfer material S to fix the toner image to the transfer material S.

A cleaner blade 391 makes contact with the intermediate transfer belt 31 after the secondary transfer of the toner image. More specifically, the cleaner blade 391 makes contact via the intermediate transfer belt 31 with the roller 33 around which the intermediate transfer belt 31 is wrapped downstream from the secondary transfer position TR2 in the transport direction D31 of the intermediate transfer belt 31. The cleaner blade 391 removes the residual deposits of toner and cleaning liquid remaining on the surface of the intermediate transfer belt 31 after the secondary transfer.

In addition to a bias generating unit for generating the bias voltage supplied to the various components in the apparatus, the secondary transfer roller 4, and the belt drive controller 32 mentioned above, the apparatus 1 is provided, as shown in FIG. 2, with a motor M5 for rotating the gate rollers 51, a driver 13 for driving this motor M5, and different types of drive mechanisms to drive the other components in the apparatus. The operations performed by these components are all controlled by the controller 10.

Also, the apparatus case in this embodiment is provided with a transfer material information input unit 100 which allows the user to set and enter transfer material information such as the type and grade of transfer material to be used. The transfer material information input unit 100 may be in a pushbutton, touch-panel or keyboard format, and receives the operational input from the user. The transfer material information can be the type of transfer material, such as paper or film, as well as the basis weight, size and surface finish (coated or uncoated, etc.) of the transfer material.

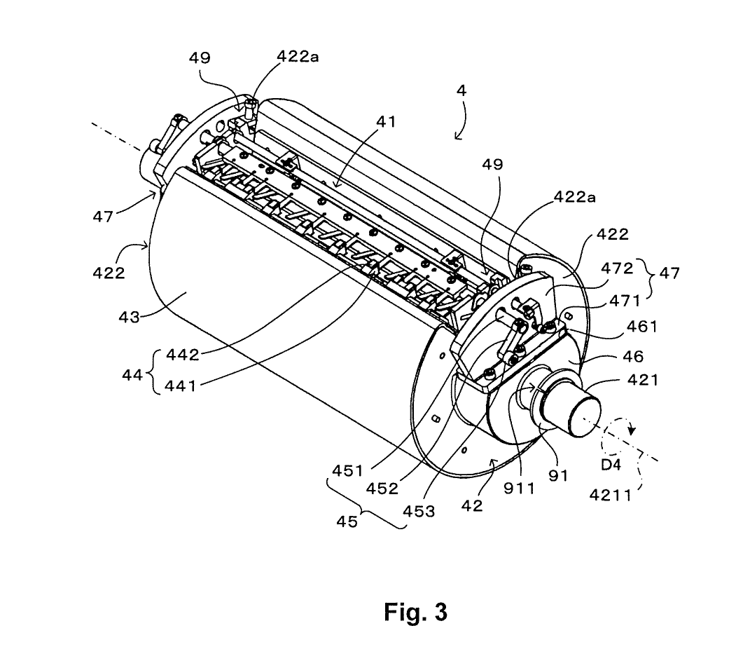

In this embodiment, the toner image is formed using the wet developing method in which a toner image is formed using a liquid developer. Therefore, a secondary transfer roller 4 having a gripping material is used to prevent sticking of the transfer material S to the intermediate transfer belt 31 while applying sufficient transfer pressure to the transfer material S. The following is a more detailed description of the structure of the secondary transfer roller 4, made with reference to FIG. 1, and FIG. 3 through FIG. 5.

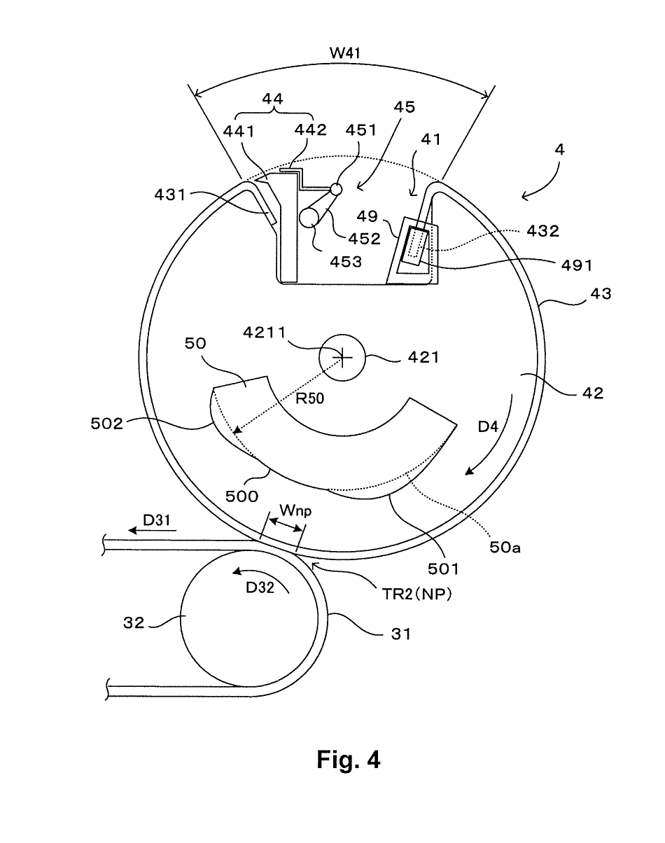

FIG. 3 is a perspective view showing the overall configuration of the secondary transfer roller. FIG. 4 is a view showing the opening and closing mechanism for the gripping material. As shown in FIG. 1 and FIG. 3, the secondary transfer roller 4 has a roller base 42 in which there is provided a recessed portion 41 composed of a cut out portion of the outer peripheral surface of the cylinder. A rotational shaft 421 is provided in the roller base 42 which extends in the direction perpendicular to the plane of the paper surface in FIG. 1. The rotational shaft 421 is centered along the shaft axis 4211 and is disposed rotatably on a support arm 40 pivotably supported by the apparatus case (not shown in the drawing). The support arm 40 is centered pivotably on its axis 401 with respect to the apparatus case, and is biased counterclockwise in FIG. 1 by biasing unit (not shown). As a result, the secondary transfer roller 4 is biased in the direction of arrow α, and is pressed against the intermediate transfer belt 31 wrapped around the belt drive roller 32. The secondary transfer roller 4 is thus pressed against the intermediate transfer belt 31 under a predetermined load (e.g., 60 kgf).

Side plates 422, 422 are attached to both ends of the rotational shaft 421. More specifically, both side plates 422, 422 are composed of disk-shaped metal plates in which a notch 422a has been formed. As shown in FIG. 3, the notches 422a, 422a face each other, and are attached to the rotational shaft 421 set apart from each other at a distance only slightly longer than the width of an elastic sheet. This forms a roller base 42 with the overall shape of a drum, having a recessed portion 41 extending parallel or almost parallel to the rotational shaft 421 in a portion of the outer peripheral surface.

A support member 46 is attached to the outer side surface of each side plate 422 at both ends of the secondary transfer roller 4, so as to rotate integrally with the roller base 42. A flat region 461 is formed in the support members 46 corresponding to the recessed portion 41. Transfer roller side abutting members 47 are attached to the flat regions 461. In the abutting members 47, the base area 471 is attached to the support members 46. The length from the base area 471 to the abutting area 472 extends in the normal direction of the flat region 461, and the front end of the abutting area 472 extends to the open end of the recessed portion 41. In other words, when an abutting member 47 is viewed from the direction of the rotational shaft 421, the abutting member 47 is disposed so that the abutting member 47 blocks the recessed portion 41, and peripheral end of the abutting area 472 partially overlaps with the peripheral surface (elastic layer 43) of the secondary transfer roller 4.

A bearing 322 (see FIG. 1) is provided on both ends of the drive roller 32 around which the intermediate transfer belt 31 is wrapped, and is coaxial with the drive roller 32 but able to rotate independently of the drive roller 32. When an abutting member 47 of the secondary transfer roller 4 faces the drive roller 32 side, the outer peripheral surface of the abutting member 47 comes into contact with the outer peripheral surface of the bearing 322.

An elastic sheet formed from an elastic material such as a rubber or resin is wrapped around the outer peripheral surface of the roller base 42. In other words, it is wrapped around the surface of the metal plate excluding the region corresponding to the inside of the recessed portion 41. An elastic layer 43 is formed by this elastic sheet. In this embodiment, the elastic sheet is not bonded to the secondary transfer roller 4 so that the elastic sheet (elastic layer 43) can be replaced when it wears out or becomes damaged over time. More specifically, one end 431 of the elastic sheet is fixed to the side surface of the recessed portion 41 using a retainer plate not shown in the drawing, and the other end 432 of the elastic sheet is attached by a plate 491. This plate 491 engages a sheet stretching unit 49 fixed to the bottom of the recessed portion 41, and the elastic sheet is stretched without slack around the peripheral surface of the secondary transfer roller 4.

In this embodiment, the length of the opening (opening width) W41 in the recessed portion 41 in the rotational direction D4 of the roller base 42 is approximately 105 mm. When the elastic layer 43 formed on outer peripheral surface of the secondary transfer roller 4 except for in the recessed portion 41 is positioned opposite the intermediate transfer belt 31, the elastic layer 43 presses against the intermediate transfer belt 31, and a transfer nip NP is formed. The length of the transfer nip NP (transfer nip width) Wnp in the rotational direction D4 of the roller base 42 is approximately 11 mm. This forms the following relationship.

(Opening width W41 of recessed portion 41)>(Transfer nip width Wnp of transfer nip NP)

Thus, the transfer nip temporarily disappears when the recessed portion 41 of the secondary transfer roller 4 is facing the intermediate transfer belt 31.

Also, the length of the elastic layer 43 in the rotational direction D4 of the roller base 42 is approximately 495 mm. It is accordingly possible to accommodate wrapping of the largest size of transfer material S that can be used in the apparatus 1. In other words, the length of the elastic layer 43 is determined so as to be greater in the rotational direction D4 of the roller base 42 than the length of any transfer material S that can be used.

A gripping material 44 for gripping the transfer material S is arranged inside the recessed portion 41. The gripping material 44 has gripper support member 441 standing proud from the inner bottom portion of the recessed portion 41 to the outer peripheral surface of the roller base 42, and a gripper member 442 detachably supported at the end of the gripper support member 441. When the opening and closing mechanism 45 described below is operated, the end of the gripper member 442 reciprocates in the diametric direction of the secondary transfer roller 4, separates from the end of the gripper support member 441, and prepares to grip and release the transfer material S. The end of the gripper member 442 moves towards the end of the gripper support member 441, and the transfer material S is gripped.

As shown in FIG. 3 and FIG. 4, the gripper member 442 is attached to the support shaft 451 of a crank arm 452 configured so as to rotate with respect to the support shaft 451. A cam follower 453 is provided at the end of the crank arm 452. The biasing member is not shown, but the end of the gripper member 442 is biased in the direction of abutting the gripper support member 441 (in the counterclockwise direction around the support shaft 451 in FIG. 4). In other words, the gripping material 44 remains closed without the application of any external force. The support shaft 451, the crank arm 452, and the cam follower 453 integrally form the opening and closing mechanism 45.

A cam member 50 is fixed to the inside surface of the apparatus case (not shown) near the axial end of the secondary transfer roller 4 and the drive roller 32. The outer peripheral surface 500 of the cam member 50 runs for the most part along an arc 50a with radius R50 centered on the rotational axis 4211 of the secondary transfer roller 4. However, protruding portions 501, 502 extend outward in the peripheral direction in certain areas. The outer peripheral surface of the cam member 50 with this outer peripheral shape, and the outer peripheral surface of the cam follower 453 disposed in the opening and closing mechanism 45 make intermittent contact as the secondary transfer roller 4 rotates. As the cam follower 453 moves along the outer peripheral shape of the cam member 50, the crank arm 452 rotates, and the end of the gripper member 442 opens and closes with respect to the gripper support member 441. In other words, in this embodiment, the gripping material 44 automatically opens and closes based on the phase rotation of the secondary transfer roller 4.

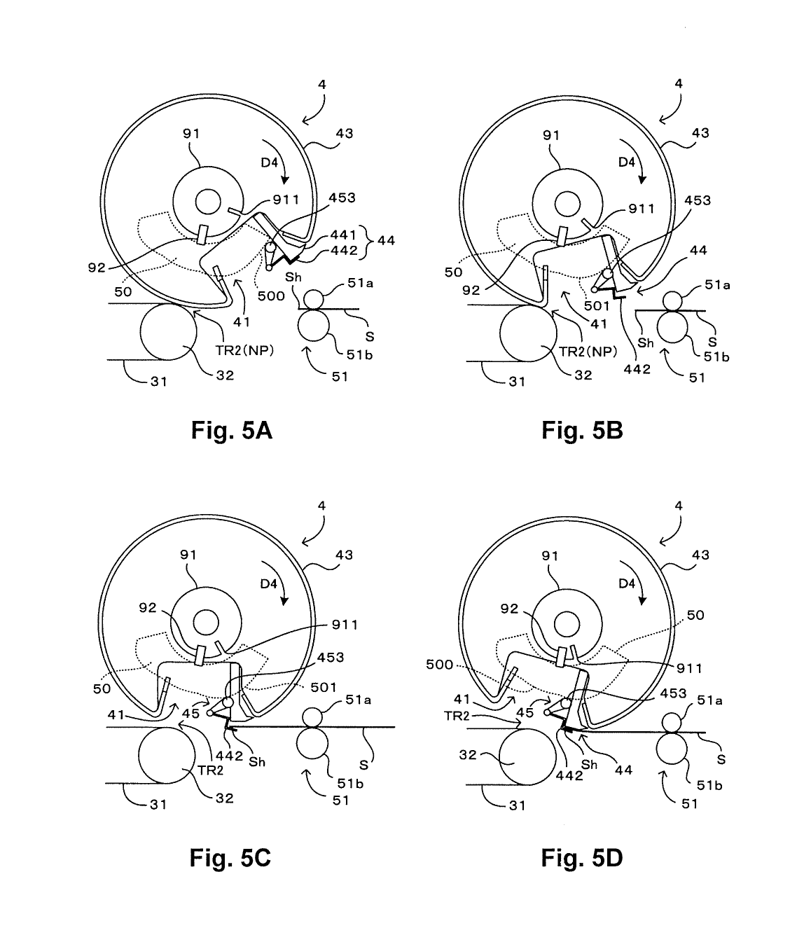

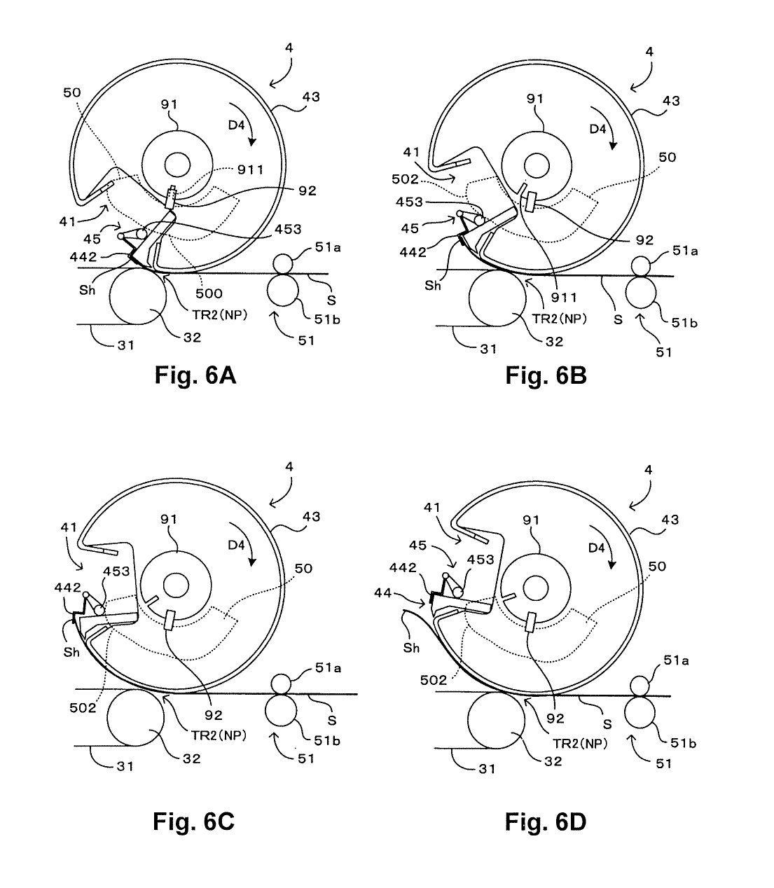

FIG. 5 and FIG. 6 are views showing the relationship between the phase rotation of the secondary transfer roller and the opening and closing of the gripping material. FIG. 5 and FIG. 6 schematically illustrate the change in the opening and closing position of the gripping material 44 based on the rotation of the secondary transfer roller 4; and, accordingly, the grip and release of the transfer material S. In order to explicitly show the gripping mechanism, the portions unrelated to the operation of the gripping material such as the abutting members 47 and the sheet stretching unit 49 have been omitted from FIG. 5 and FIG. 6. When the recessed portion 41 of the secondary transfer roller 4 is in a position far from the secondary transfer position TR2 as shown in FIG. 4, the cam follower 453 is separated from the cam member 50, and the gripping material 44 remains closed due to the action of the biasing member not shown in the drawing.

When the secondary transfer roller 4 rotates in direction D4, as shown in FIG. 5a, the recessed portion 41 approaches the secondary transfer position TR2, and the cam follower 453 begins to approach the outer peripheral surface 500 of the cam member 50. As it continues to rotate, as shown in FIG. 5B, the cam follower 453 runs up against the first protruding portion 501 on the outer peripheral surface 500 of the cam member 50. The crank arm 452 rotates around the support shaft 451, and the front end of the gripper member 442 begins to separate from the gripper support member 441. During the actual image forming operation, the gate rollers 51 begin to rotate in response to the rotation of the secondary transfer roller 4, and a transfer material S is transported towards the second transfer position TR2. The symbol Sh denotes the front end of the transfer material S in the transfer material transport direction.

As shown in FIG. 5C, when the rotation continues and the recessed portion 41 faces the secondary transfer position TR2, the nip temporarily disappears. The gripping material 44 opens wider and receives the front end Sh of the transfer material S transported by the gate rollers 51. In other words, the front end Sh of the transfer material is inserted between the opened gripper member 442 and gripper support member 441. At this time, the front end Sh of the transfer material strikes the gripper member 442. This sets the positional relationship between the phase rotation of the secondary transfer roller 4 and the front end Sh of the transfer material with greater precision and greater reproducibility. Any skew of the transfer material S can be corrected.

When this state passes, the outer peripheral surface 500 of the cam member 50 assumes a configuration of gradual withdrawal. When the secondary transfer roller 4 rotates further, the opening in the gripping material 44 becomes smaller. Finally, as shown in FIG. 5D, it closes completely and the grip on the transfer material S is complete. The transfer material S gripped at the front end Sh is sent to the secondary transfer position TR2.

Next, as shown in FIG. 6A, the recessed portion 41 passes the secondary transfer position TR2, and the elastic layer 43 of the secondary transfer roller 4 comes into contact with the intermediate transfer belt 31 via the transfer material S. In other words, the transfer material S is sandwiched in the nip NP between the elastic layer 43 of the secondary transfer roller 4 and the intermediate transfer belt 31. The grip is maintained on the front end Sh of the transfer material by the gripping material 44 until at least the front end Sh of the transfer material has passed through the nip NP. This prevents the transfer material S from becoming stuck to the intermediate transfer belt 31.

Also, the positional relationship between the photosensor cam 91 and the photosensor 92 is established so that, at this time, when the elastic layer 43 of the secondary transfer roller 4 makes contact with the intermediate transfer belt 31 via the transfer material S and begins to form a transfer nip NP, the notch 911 in the photosensor cam 91 passes the detection position for the photosensor 92.

When the rotation continues, as shown in FIG. 6B, the cam follower 453 approaches the second protruding portion 502 on the outer periphery of the cam member 50. The cam follower 453 runs up against the protruding portion 502, and the gripping material 44 opens up again. After the front end Sh of the transfer material has been released as shown in FIG. 6C, contact between the cam follower 453 and the cam member 50 ends, and the gripping material 44 is closed.

In this embodiment, the rotation of the secondary transfer roller 4 changes the contact state between the cam follower 453 on the secondary transfer roller 4 side and the cam member 50 on the apparatus case side. This opens and closes the gripping material 44 to grip and release a transfer material S.

In this embodiment, as mentioned above, the transfer material S is guided to the transfer nip NP while being gripped at the front end Sh in the transfer direction by a gripping material 44 disposed on the secondary transfer roller. When the transfer nip NP has been passed, the grip of the gripping material 44 is released, and the transfer material S is free. At this time, when the transfer material S has separated from the peripheral surface of the secondary transfer roller 4, the “in-transit adhesion” phenomenon explained below sometimes occurs.

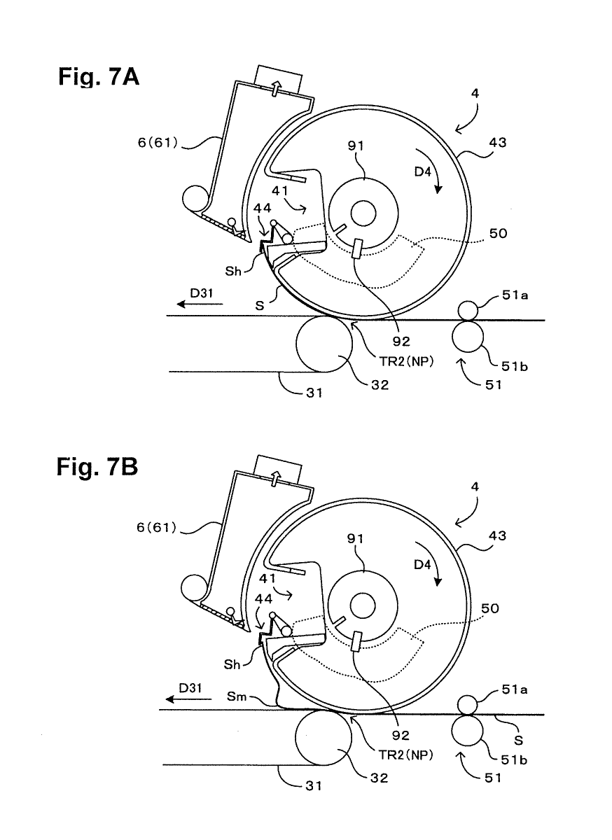

FIG. 7 is a view used to explain the in-transit adhesion phenomenon. In this embodiment, the transfer nip NP is positioned in the vertical direction below the horizontal plane through which the rotational axis 4211 of the secondary transfer roller 4 passes. While the transfer material S is being gripped by the gripping material 44, the transfer material S is pressed against by the gripping material 44 and the transfer nip NP, and transported towards the transport mechanism 6 by the rotation of the secondary transfer roller 4 while being caused to adhere to the peripheral surface of the secondary transfer roller 4. Here, as shown in FIG. 7A, when released from the gripping material 44 in the vertical direction above the transfer nip NP and below the rotational axis 4211 of the secondary transfer roller 4, or below the extension direction from the virtual horizontal plane perpendicular to the vertical direction including the rotational axis 4211 of the secondary transfer roller 4, the free front end Sh of the transfer material S starts to fall off. Therefore, the transfer material S is displaced in the direction of separation from the peripheral surface of the secondary transfer roller 4. As a result, the transport force for the transfer material S obtained by adhesion to the secondary transfer roller 4 declines.

If the transport force for the discharged transfer material S weakens as the transfer material S is being discharged from the transfer nip NP, the transfer material S remains in the transfer nip NP to the rear and becomes loose. The surface tension of the liquid component of the liquid developer remaining between the transfer material S passed through the transfer nip NP and the intermediate transfer belt 31 causes the transfer material S and the intermediate transfer belt 31 to readily stick together. As a result, as shown in FIG. 7B, the middle portion Sm of the transfer material S passed through the transfer nip NP sticks to the intermediate transfer belt 31. This phenomenon is called “in-transit adhesion” in this specification.

Coiling is a phenomenon that can occur even when the front end of the transfer material separates properly using the air blower separation described in Patent Citation 2 or mechanical separation using a separating claw. Also, unlike an apparatus with a structure in which the transfer material is delivered between gripping claws disposed on multiple rollers as in an offset printing device, this phenomenon is a problem for configurations with a time period in which the transfer material is temporarily not gripped or suctioned. This phenomenon was previously unknown.

In this embodiment, the problem is addressed by pressing the transfer material S against the peripheral surface of the secondary transfer roller 4 not only by directing an airflow towards the transfer nip NP but also by directing an airflow at the peripheral surface of the secondary transfer roller 4 after passage through the transfer nip NP while transporting the transfer material.

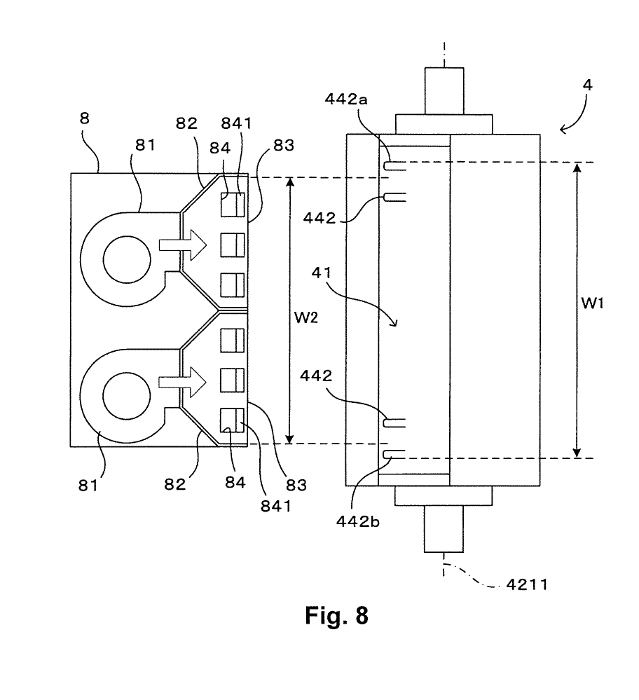

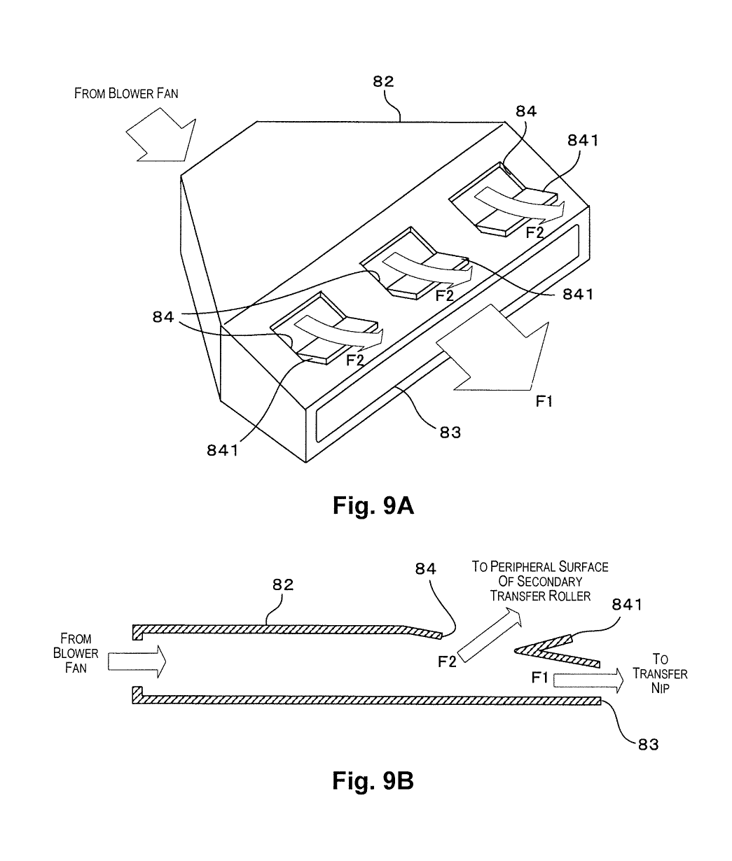

FIG. 8 is a view of the secondary transfer roller and the blower unit from above. FIG. 9 is view showing the shape of the case for the blower unit. More specifically, FIG. 9A is a perspective view of the case 82, and FIG. 9B is a cross-sectional side view of the case 82. The blower unit 8 has, for example, blower fans 81, 81 serving as the airflow generators, and cases 82, 82 having an opening 83 connected to the blower fan 81 at the other end. The airflow generated by the blower fan 81 passes through the case 82, is discharged from the opening near the transfer nip NP where the secondary transfer roller 4 makes contact with the intermediate transfer belt 31, and is directed towards the transfer nip NP (symbol F1). In this embodiment, two pairs of blower fans 81 and cases 82 are aligned in the direction of the rotational axis 4211 of the secondary transfer roller 4 so that the airflow is equalized in the axial direction.

An opening 84 is also made in the upper portion of the case 82 (in front of the plane of the paper surface in FIG. 8), and a current plate 841 is provided in the opening 84. The opening 84 and current plate 84 can be easily created by cutting a C-shaped slit in the plate constituting the upper surface of the case 82 and then bending the cut-out towards the outside. Some of the airflow generated by the blower fan 81 is discharged from the opening 84, and the airflow discharged from the opening 83 is separated by the current plate 841 and directed towards the peripheral surface of the secondary transfer roller 4 that has passed the transfer nip NP (symbol F2).

Because the transfer material S is wrapped around the peripheral surface of the secondary transfer roller 4, the airflow discharged from the opening 84 is directed towards the image transfer surface of the transfer material S wrapped around the peripheral surface of the secondary transfer roller. The airflow presses the transfer material S against the peripheral surface of the secondary transfer roller 4, and maintains the positioning of the transfer material S. Transport force is applied to the transfer material S due to adhesion to the secondary transfer roller 4. In the embodiment, this prevents the occurrence of “in-transit adhesion” of the transfer material.

As shown in FIG. 8, the opening width W2 of the opening 83 in the blower unit 8 in the axial direction of the secondary transfer roller 4 is smaller than the width W1 between the two gripper members 442a, 442b positioned on the outermost side in the axial direction among the gripper members 442 provided in the recessed portion 41 of the secondary transfer roller 4 in the axial direction. The width W1 between the gripper members 442a, 442b is set based on the width of the transfer material S. More specifically, it is about the same width as the transfer material S. For example, for an A3-size transfer material according to the Japanese Industrial Standards (width: 297 mm), the width W1 between the gripper members 442a, 442b is 300 mm, and the opening width W2 for the opening 83 in the blower unit 8 is approximately 320 mm. Also, the opening height for the opening 83 and the dimensions of the opening 83 in the direction perpendicular to the plane of the paper surface in FIG. 8 can be, for example, 15 mm.

Therefore, the airflow that has been discharged from the opening 83 and that has struck the peripheral surface of the secondary transfer roller 4 flows smoothly and broadens outward with respect to the axial direction of the secondary transfer roller 4. This avoids flapping of the transfer material S due to turbulence. Here, the blower fan 81 can be a super silent blower manufactured by NIDEC Servo Corporation.

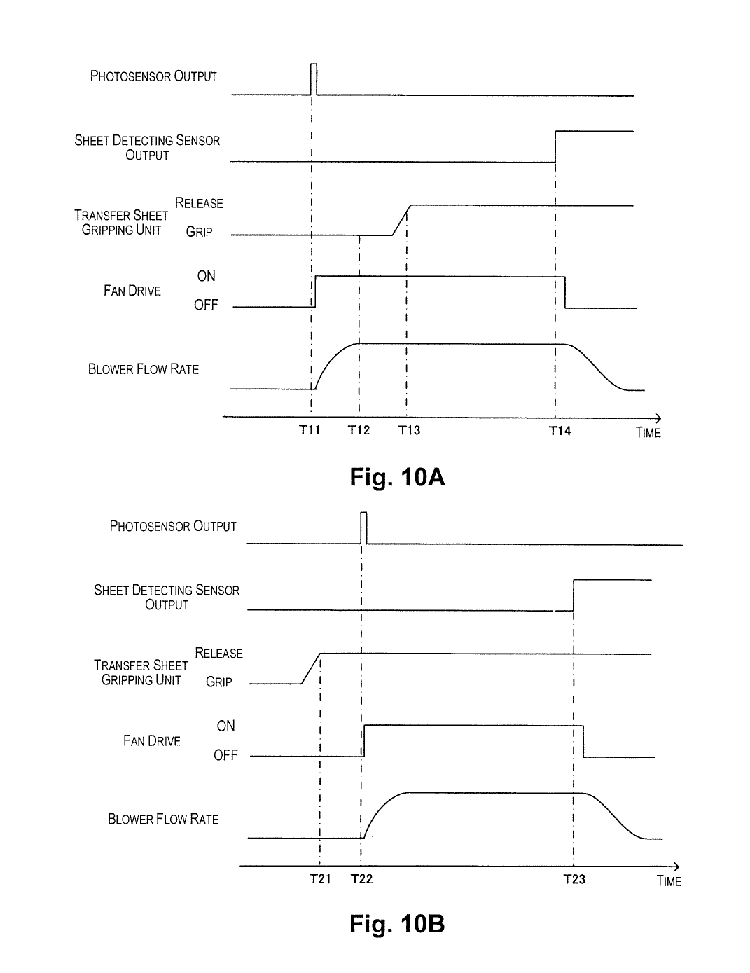

FIG. 10 is a view showing the operating sequence for the blower unit. In the first sequence example shown in FIG. 10A, the airflow from the blower unit 8 begins while the front end Sh of the transfer material S passing through the transfer nip NP is being gripped by the gripping material 44, that is, before the transfer material S is released by the gripping material 44. In this way, the grip is released on the transfer material S passed through the transfer nip NP while it is being pressed against the peripheral surface of the secondary transfer roller 4 by the airflow. This prevents the transfer material S from coming off the secondary transfer roller 4 and sagging.

More specifically, the operations indicated in the timing chart of FIG. 10A are performed. When the recessed portion 41 of the secondary transfer roller 4 has passed the secondary transfer position TR2, and the elastic layer 43 on the peripheral surface has come into contact with the intermediate transfer belt 31 via the transfer material S to begin forming the transfer nip NP, a synchronization signal is outputted from the photosensor 92 (Time T11). The time at which a synchronization signal is outputted is not limited to the time at which the transfer nip begins to form. However, a time at which the transfer material S is being reliably gripped by the gripping material 44 is preferred.

When the synchronization signal is outputted, the controller 10 outputs a drive signal to drive the blower fan 81 in the blower unit 8. This activates the blower unit 8, and the airflow from the blower unit 8 begins to be directed towards the secondary transfer roller 4. The airflow is gradually increased after the fan has been activated, and a substantially constant value is reached at given time T12.

As the rotation of the secondary transfer roller 4 advances, the gripper member 442 in the gripping material 44 is rotated by the action of the opening and closing mechanism 45 and the cam member 50. The gripper member moves away from the gripper support member 441, the grip is released, and the transfer material S is released (Time T13). Because the gripper member 442 gradually opens with the rotation of the secondary transfer roller 4, it is difficult to specifically identify the time at which the transfer material S is released. However, the time at which the interval between the gripper member 442 and the gripper support member 441 gradually increases to reach the thickness of the transfer material S can be defined as the time at which the transfer material S is released.

When the airflow is continued after the release of the transfer material S, the positioning of the transfer material S can be maintained. When the front end Sh of the transfer material S reaches the transport mechanism 6, it is subsequently transported by the transport mechanism 6. As a result, the transfer material S does not sag. Thus, after the transfer material S has been delivered from the secondary transfer roller 4 to the transport mechanism 6, the airflow can be weakened or stopped. When the transfer material S reaching the transport mechanism has been detected by the sheet detecting sensor 612 disposed in the first suction unit 61 (Time T14), the controller 10 turns off the drive signal to the blower fan 81. This gradually reduces the airflow, which eventually stops. In order to more reliably maintain the positioning of the transfer material S on the peripheral surface of the secondary transfer roller 4, a weak airflow can be continued.

In the sequence described above, a transfer material S passed through the transfer nip NP and released by the gripping material 44 is pressed against the peripheral surface of the secondary transfer roller 4 by the airflow from the blower unit 8 started before the grip was released. As a result, the transfer material S is sent to the transfer mechanism 6 in the next stage while remaining on the peripheral surface of the secondary transfer roller 4, without separating from the peripheral surface of the secondary transfer roller 4 and sagging, and without touching the blower unit 8 or other members.

The released transfer material S does not sag immediately. Its positioning is maintained by the firmness of the transfer material, that is, the ability of the transfer material to retain its own shape. What this means from the standpoint of preventing sagging of the transfer material is that the airflow should occur for a certain period of time after the grip has been released. Therefore, the airflow should begin after the grip has been released. This is especially so when a firm transfer material is used such as relatively heavy paper.

This is taken into account in the second sequence example shown in FIG. 10B, in which the airflow begins after the transfer material S has been released by the gripping material 44. This example assumes that a synchronization signal is outputted from the photosensor 92 after the transfer material S has been released by the gripping material 44. On this point, it is necessary that the position of the photosensor shown in FIG. 1 or that the mounting angle of the photosensor cam 91 relative to the secondary transfer roller 4 be changed. Also, any signal able to verify the release of the gripping material 44 will suffice as the synchronization signal. For example, a signal can be obtained from a microswitch used to detect the opening and closing of the gripper member 442.

In the sequence shown in FIG. 10B, the grip on the transfer material S by the gripping material 44 is released at Time T21. Afterwards, a synchronization signal is outputted from the photosensor 92 (Time T22). When the synchronization signal is detected, the controller 10 sends a drive signal to the blower fan 81. This starts up the airflow from the blower unit 8. The rest of the operations is similar to the first example. When the transfer material S reaching the first suction unit 61 has been detected by the sheet detecting sensor 612 (Time T23), the drive signal to the blower fan 81 is stopped, and the airflow is ended.

If the airflow is started after the transfer material S has been released by the gripping material 44, the positioning of the released transfer material S can be controlled, and transported on the peripheral surface of the secondary transfer roller 4. Therefore, as in the example described above, a conveying force is imparted to the transfer material S by the rotation of the secondary transfer roller 4, and the transfer material S can be sent to the transfer mechanism 6 in the next stage while in an unchanged position on the peripheral surface of the secondary transfer roller 4, without separating from the peripheral surface of the secondary transfer roller 4 or sagging, and without touching the blower unit 8 or other members.

More preferably, Time T22, at which the airflow begins, should be later than the time at which the front end Sh of the transfer material S passes the position of maximum airflow from the blower unit 8 (whether or not the transfer material has been released by the gripping material at this time). This can prevent separation of the transfer material S from the secondary transfer roller 4 due to the airflow.

The shape retaining ability of the transfer material S and the readiness of the transfer material to stick to the intermediate transfer belt 31 depends largely on the nature of the transfer material itself. For example, if the transfer material is paper, it depends largely on the thickness of the paper, the firmness of the paper, and the condition of its surface (coated or uncoated). Therefore, in this embodiment, the basis weight (mass per unit area) and the presence or absence of a surface coating are entered by the user as information indicating the nature of the transfer material, and the flow rate (blower speed) for the airflow generated by the blower unit 8 is adjusted based on this. In this way, the flow rate of the airflow directed at the transfer nip NP and the peripheral surface of the secondary transfer roller 4 can be changed.

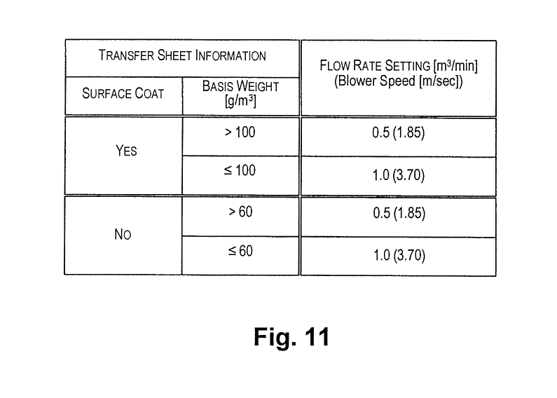

FIG. 11 is a view showing an example of flow rate settings. Because surface-coated paper does not absorb much liquid as a general feature, the surface tension of the liquid component remaining between the paper and the intermediate transfer belt 31 causes the paper to stick to the intermediate transfer belt 31. This tends to occur less often in the case of uncoated paper, which more readily absorbs the liquid. When the surface characteristics are the same, heavier paper, which tends to be thicker, has more ability to retain its shape on the basis of basis weight than lighter paper.

From the above, in this embodiment, the airflow from the blower unit 8 can be changed to two stages by controlling the voltage applied to the blower fan 81. As shown in FIG. 11, the airflow is selected by combining the basis weight and the presence or absence of a surface coating on the transfer material S to be used. Specifically, the user is prompted before the image forming operation begins to enter the basis weight and the presence or absence of a surface coating on the transfer material into the transfer material information input unit 100, and the airflow of the blower unit 8 is set based on the table in FIG. 11 using the information obtained from the entered results as the transfer material information. When the image forming operation is executed, the operation is executed using the set airflow based on the sequence shown in FIG. 10.

Specifically, when the basis weight of surface-coated paper exceeds 100 g/m³, the airflow is set to low. If the basis weight is equal to or less than this value, the airflow is set to high. When the basis weight of uncoated paper exceeds 60 g/m³, the airflow is set to low. If the basis weight is equal to or less than this value, the airflow is set to high. The threshold value for the basis weight of coated paper is higher than the threshold value for uncoated paper because coated paper is more likely than uncoated paper to stick to the intermediate transfer belt 31. In effect, the airflow is set to high to the extent that the basis weight is great and the firmness is high.

In this embodiment, as mentioned above, a two-directional airflow is generated from the blower unit 8 disposed on the outlet end of the transfer nip NP from which the transfer material S is discharged. More specifically, an airflow is directed at the transfer nip NP, and an airflow is direction at the peripheral surface of the secondary transfer roller 4 having passes through the transfer nip NP. The airflow directed towards the transfer nip NP has the effect of separating the transfer material S that has passed through the transfer nip NP from the intermediate transfer belt 31. The airflow directed towards the peripheral surface of the secondary transfer roller 4 has the effect of pressing the transfer material S that has passed through the transfer nip NP against the surface peripheral surface of the secondary transfer roller 4 so as to conform to the surface. In this way, the rotation of the secondary transfer roller 4 provides reliable transport force to the transfer material S so that the transfer material S reaches the transport mechanism 6.

In this configuration, because a transfer material S that has passed through the transfer nip NP can be reliably separated from the intermediate transfer belt 31, applied to the peripheral surface of the secondary transfer roller 4, and transported, several problems are forestalled, such as the transfer material S sticking to the intermediate transfer belt 31 or the transfer material touching the blower unit 8 or other peripheral members and damaging the image. In particular, the embodiment has the superior effect of preventing the “in-transit adhesion” phenomenon in which the middle portion of the transfer material S sticks to the intermediate transfer belt 31.

The transfer mechanism 6 in this embodiment is provided with a first suction unit 61 without transport capability for maintaining suction on the transfer material S between the secondary transfer roller 4 and the transfer material transport unit 62 for actively transporting the transfer material S towards the rear. The first suction unit 61 exerts a type of braking effect on the movement of the transfer material S. However, in this embodiment, the transfer material S is reliably advanced by the transport force applied by the secondary transfer roller 4. As a result, any concerns related to transport being adversely affected by the first suction unit 61 are eliminated.

Also, in this embodiment, the airflow from the blower unit 8 is set based on information indicating the nature of the transport sheet S, more specifically, the weight and the presence or absence of a surface coating. In this way, the airflow can be adjusted based on the likelihood of sticking to the intermediate transfer belt 31 and sagging, which differ depending on the type of transfer material S. The transfer material S can then be more reliably transported along the transport route PT.

In this embodiment, as explained above, the secondary transfer roller 4 and the intermediate transfer belt 31 function, respectively, as the “transfer roller” and the “image carrier belt” of the invention. The controller 10 functions as the “control unit” of the invention, and the gripping material 44 functions as the “gripping material” of the invention. In this embodiment, the transport mechanism 6 functions as the “transport unit.” The blower unit 8 in this embodiment functions as the “airflow-generating unit” in the invention.

In this embodiment, the transfer material information input unit 100 functions as the “transfer material information input unit” of the invention, and the controller 10 functions as the “control unit” of the invention. Airflow F1 and F2 shown in FIG. 9 correspond, respectively, to the “first airflow” and the “second airflow” of the invention.

The invention is not limited to the above described embodiment, and various variations and modifications may be possible without departing from the scope of the invention. For example, in the embodiment, airflows were generated in two directions by a case 82 having two types of openings 83, 84 opening in different directions. However, airflows can certainly be generated in two directions by separate airflow generators. In this case, the flow rates of the two airflows are adjusted independently, or only one of the airflows is adjusted. The timing for the airflows can also be varied.

In this embodiment, for example, the transfer material is gripped and released by an opening and closing mechanism 45 and a cam member 50 operated mechanically based on the phase rotation of the secondary transfer roller 4. However, the invention is not restricted to this arrangement. For example, the gripping and release of the transfer material can be controlled electrically using a motor or a solenoid.

In this embodiment, for example, the blower fan 81 and the case 82 are combined to constitute the blower unit 8, but the source of the airflow is not limited to a fan system. For example, a compressor can be used. The source of the airflow does not have to be incorporated into the device material.

The operating sequence for the blower unit 8 in this embodiment merely illustrates a typical example. The invention is not limited to this example. In particular, the technological concept in this embodiment requires blowing air on the transfer nip NP and the image transfer surface of the transfer material S discharged from the transfer nip NP. However, there are no restrictions on the timing used to stop the blowing of air. Therefore, stopping the blowing of air based on the output from the sheet detecting sensor 612 is not an essential configurational element.

This embodiment has a configuration in which a gripping material 44 is provided in the recessed portion 41 of the secondary transfer roller 4, and the transfer material S is guided to the transfer nip NP while being gripped by the gripping material 44. However, the invention can be applied by an image forming apparatus without a recessed portion and a gripping material if the transfer material is transmitted to the transfer nip between an image carrier belt and a transfer roller. In particular, the invention can be advantageously applied to an image forming apparatus using a liquid developer. This uses a developer in which toner is dispersed in a liquid carrier.

What is claimed is:

1. An image forming apparatus, comprising:
an image carrier belt on which carrying an image;
a transfer roller that rotates on a rotating shaft and forms a transfer nip with the image carrier belt downward in a vertical direction from a virtual horizontal plane perpendicular to the vertical direction including a centerline of the rotating shaft; and
An airflow-generating unit that generates a first airflow directed between the image carrier belt and a surface transferred the image of a transfer material toward the transfer nip and a second airflow directed towards the surface of the transfer material from below in vertical direction along outer circumference of the transfer roller.

2. The image forming apparatus of claim 1, wherein
the transfer roller has a concaved portion disposed on an outer circumference of the transfer roller; and a gripping member that grips a transfer material is disposed in the concaved portion.

3. The image forming apparatus of claim 2, wherein
the gripping member grips the transfer material, transports the transfer material to the transfer nip, and releases the transfer material transferred the image in the transfer nip, the transfer material being released downward in the vertical direction from the virtual horizontal plane.

4. The image forming apparatus of claim 1, further comprising
a transport unit that transports the transfer material so that the transfer surface transferred the image of the transfer material is facing downward in the vertical direction.

5. The image forming apparatus of claim 1 further comprising:
a transfer material information input unit to which an information on the transfer material is inputted; and
a control unit that controls a flow rate of at least one of the first airflow and the second airflow based on the information on the transfer material inputted by the transfer material information input unit.

6. An image forming method, comprising:
transferring an image carried by an image carrier belt to a transfer material through a transfer nip formed by the image carrier belt and a transfer roller downward in the vertical direction from a virtual horizontal plane perpendicular to the vertical direction and including a center of rotation of the transfer roller;
transporting the transfer material transferred the image and separating the transfer material from the image carrier belt while generating a first airflow between the image carrier belt and a transfer surface transferred the image of the transfer material; and
directing a second airflow downward in the perpendicular direction against the transfer surface of the transfer material separated from the image carrier belt.

7. The image forming method of claim 6, wherein
the transfer material against which the second airflow is directed is transported while being suctioned upward in the vertical direction.
